(19) United States
(12) Patent Application Publication
(10) Pub. No.: US 2023/0106337 A1
(43) Pub. Date: Apr. 6, 2023

(54) MARKETING MANAGEMENT SYSTEM, BUSINESS MANAGEMENT SYSTEM, PROCESSES, AND METHOD FOR MANAGING DIGITAL MARKETING PROFILES

(71) Applicant: Ella Interactive, Melville, NY (US)

(72) Inventors: Melissa Psihudakis, Melville, NY (US); Jake Sheets, Brightwaters, NY (US)

(73) Assignee: Ella Interactive, Melville, NY (US)

(21) Appl. No.: 17/494,895

(22) Filed: Oct. 6, 2021

(51) Int. Cl. G06Q 30/02; G06Q 30/00; G06Q 10/06; G06Q 10/10; G06N 20/00

(52) U.S. Cl. CPC G06Q 30/0201; G06Q 30/01; G06Q 30/0276; G06Q 30/0246; G06Q 10/06316; G06Q 10/1097; G06N 20/00

(57) ABSTRACT

The present disclosure relates to a marketing management system, a business management system, processes, and methods of use. The present disclosure provides for integration of a plurality of accounts for management for firms and the like. Furthermore, the integrations with ecommerce, phone services, online services, social media services, and task management provide for further simplification and management. In this way, the present disclosure also provides for designing, creating, and launching ads and/or advertisement campaigns, based on a product and/or service, of different variations, through different accounts, while dynamically modifying graphics and the like. More specifically, and without limitation, the present disclosure relates to a digital marketing profile management system. More specifically, and without limitation, the present disclosure relates to a system for digital marketing management and the organization and task management associated with various profiles for marketing, and specifically digital marketing in business operations.

### FIELD OF THE DISCLOSURE

This disclosure relates to a marketing management system, a business management system, processes, and methods of use. More specifically, and without limitation, the present disclosure relates to a digital marketing profile management system. More specifically, and without limitation, the present disclosure relates to a system for digital marketing management and the organization and task management associated with various profiles for marketing, and specifically digital marketing in business operations.

### COPYRIGHT NOTICE

At least a portion of the disclosure of this patent document contains material that is subject to copyright protection. The copyright owner has no objection to the facsimile reproduction by anyone of the patent document or the patent disclosure, as it appears in the Patent and Trademark Office patent files and/or records, but otherwise reserves all copyright rights whatsoever. The following notice applies to the software and data as described below and in the drawings that form a part of this document. Copyright Ella Interactive LLC. All rights reserved.

### BACKGROUND OF THE DISCLOSURE

Advertising is old and well known in the art. Generally speaking, advertising is a communication, typically from a business, for the purpose of sending a message to promote and/or sell a product and/or service. Today, billions of dollars are spent by advertisers in developing, promoting, and distributing these messages. Advertising message commonly include the development and/or creation of content for the purpose of selling. Advertising commonly includes putting that content in front of an audience such as purchasers or potential customers. This may include putting content on television, newspapers, commercials, magazines, radio, direct mail, blogs, social media, websites, phone calls, text messages, and more. Furthermore, this also means that advertising and/or marketing content can come in a variety of forms from video messages, audio messages, written messages, person to person communications, social media messages, images, a combination of, and more.

Digital marketing is a specific type of marketing and/or advertising that generally utilizes the internet and/or online sources for advertising. Digital marketing has grown dramatically in recent decades, since the advent of the internet, and is trending opposite of print media in adoption and usage. A reason for this trend is the usage of digital advertising. As opposed to traditional print and/or newspaper advertising, digital marketing can reach greater audiences and/or targeted audiences and have a much greater and/or efficient impact on the audience reached. Digital marketing can be found on computers, smartphones, smart devices, various media platforms, and the like.

Digital marketing is further growing in influence and popularity because of its unique ability to employ other tools within digital marketing and the internet and target more relevant audiences. Some examples of how and why digital marketing has become more prevalent are the ability to utilize search engines and/or harness search engine optimization, the ability to integrate search engine marketing, content specific marketing creation, influencer marketing through social media such as through Youtube, Twitter, Instagram, Facebook, Google, and other entities, among many other forms and tools of digital marketing. All of these tools and many other tools create the ability to create personalized content through many brand centered blogs, social media, videos, landing pages, and the like. Furthermore, digital marketing often allows for tracking data related to what the audience is that is being reached, average age of the audience, clicks, targeting a certain audience for advertising and more.

With all of the advancements and enhancements digital marketing has provided since its advent, has also come along with the same compounded number of issues. While digital marketing provides a great, complex tool; the typical business person or advertiser can have great difficulty without extensive training in managing, understanding, and utilizing the various tools and complexities of digital marketing.

Complicating matters further, digital marketing often requires an advertiser to need to work with many other entities in order to achieve a result. For example, a single digital marketing advertisement may require in house coordination for which products to advertise and what sales numbers are, coordination with a marketing creator to create content, coordination with influencers, coordination with various social media platforms—and put simply cost, content, and coordination with individuals and entities located around the country and/or around the world to achieve simple advertisements for a simple demographic.

Furthermore, various analytics and other information may come back as a result of launching an advertisement and/or advertisement campaign. Subsequently, understanding the results, synchronization of results, and utilizing results of an advertisement and/or advertisement campaign, and putting this data to use can be complex and challenging.

Thus, there is a need in the art for a complex system which can simplify digital marketing and provide a method of use for easily managing digital marketing profiles, creation of content, launching content toward a targeted audience, interacting with various entities, assigning tasks, and more.

The disclosure herein provides these advantages and others as will become clear from the specification and claims provided.

### SUMMARY OF THE DISCLOSURE

A marketing management system, a business management system, processes, and methods of use are presented. More specifically, and without limitation, the present disclosure relates to a digital marketing profile management system. More specifically, and without limitation, the present disclosure relates to a system for digital marketing management and the organization and task management associated with various profiles for marketing, and specifically digital marketing in business operations.

Thus, the present disclosure provides for a marketing management system, a business management system, processes, and methods of use that improves upon the state of the art.

Another object of the disclosure is to provide a marketing management system, a business management system, processes, and methods of use that helps businesses manage their digital marketing profiles.

Yet another object of the disclosure is to provide a marketing management system, a business management system, processes, and methods of use that helps users manage their assets.

Another object of the disclosure is to provide a marketing management system, a business management system, processes, and methods of use that helps users manage their digital marketing assets.

Yet another object of the disclosure is to provide a marketing management system, a business management system, processes, and methods of use that helps businesses manage their tasks.

Another object of the disclosure is to provide a marketing management system, a business management system, processes, and methods of use that helps users manage their digital marketing tasks.

Yet another object of the disclosure is to provide a marketing management system, a business management system, processes, and methods of use that helps businesses manage their digital marketing in a single platform.

Another object of the disclosure is to provide a marketing management system, a business management system, processes, and methods of use that provides cloud storage for images, videos and other content.

Yet another object of the disclosure is to provide a marketing management system, a business management system, processes, and methods of use that provides third party integration to other entity products and services.

Another object of the disclosure is to provide a marketing management system, a business management system, processes, and methods of use that provides website analytics.

Yet another object of the disclosure is to provide a marketing management system, a business management system, processes, and methods of use that provides phone and/or conversation tracking.

Another object of the disclosure is to provide a marketing management system, a business management system, processes, and methods of use that is relatively affordable compared to other marketing agencies.

Yet another object of the disclosure is to provide a marketing management system, a business management system, processes, and methods of use that can be utilized by a small business.

Another object of the disclosure is to provide a marketing management system, a business management system, processes, and methods of use that provides task management.

Yet another object of the disclosure is to provide a marketing management system, a business management system, processes, and methods of use that provide task assignment and updates of tasks.

Another object of the disclosure is to provide a marketing management system, a business management system, processes, and methods of use that provides a graphic library for storing and creating content related to digital marketing.

Yet another object of the disclosure is to provide a marketing management system, a business management system, processes, and methods of use that provides a graphics generator.

Another object of the disclosure is to provide a marketing management system, a business management system, processes, and methods of use that provides a digital marketing content generator.

Yet another object of the disclosure is to provide a marketing management system, a business management system, processes, and methods of use that provides a content generator for social media.

Another object of the disclosure is to provide a marketing management system, a business management system, processes, and methods of use that can autonomously generate content for social media advertising.

Yet another object of the disclosure is to provide a marketing management system, a business management system, processes, and methods of use that can generate social media content for digital marketing based on a predetermined set of rules.

Another object of the disclosure is to provide a marketing management system, a business management system, processes, and methods of use that tracks sessions.

Yet another object of the disclosure is to provide a marketing management system, a business management system, processes, and methods of use that tracks pages.

Another object of the disclosure is to provide a marketing management system, a business management system, processes, and methods of use that tracks conversions.

Yet another object of the disclosure is to provide a marketing management system, a business management system, processes, and methods of use that quantifies data into easy to understand information.

Another object of the disclosure is to provide a marketing management system, a business management system, processes, and methods of use that quantifies metrics into useful information.

Yet another object of the disclosure is to provide a marketing management system, a business management system, processes, and methods of use that improves on a businesses social media presence.

Another object of the disclosure is to provide a marketing management system, a business management system, processes, and methods of use that provide for scheduling digital marketing posts.

Yet another object of the disclosure is to provide a marketing management system, a business management system, processes, and methods of use that provide search engine optimization management.

Another object of the disclosure is to provide a marketing management system, a business management system, processes, and methods of use that can connect to a variety of third party entities.

Yet another object of the disclosure is to provide a marketing management system, a business management system, processes, and methods of use that provide for connecting to a variety of third party profiles.

Another object of the disclosure is to provide a marketing management system, a business management system, processes, and methods of use that provide phone number purchasing.

Yet another object of the disclosure is to provide a marketing management system, a business management system, processes, and methods of use that provide email marketing.

Another object of the disclosure is to provide a marketing management system, a business management system, processes, and methods of use that provide short message service marketing.

Yet another object of the disclosure is to provide a marketing management system, a business management system, processes, and methods of use that provide automatic search engine optimization auditing.

Another object of the disclosure is to provide a marketing management system, a business management system, processes, and methods of use that provide feedback for various auditing features.

Yet another object of the disclosure is to provide a marketing management system, a business management system, processes, and methods of use that provide a keyword research tool.

Another object of the disclosure is to provide a marketing management system, a business management system, processes, and methods of use that provide an all in one digital marketing platform.

Yet another object of the disclosure is to provide a marketing management system, a business management system, processes, and methods of use that provide task management and creation of advertising campaigns.

Another object of the disclosure is to provide a marketing management system, a business management system, processes, and methods of use that connect to various accounts.

Yet another object of the disclosure is to provide a marketing management system, a business management system, processes, and methods of use that connect to multiple accounts simultaneously.

Another object of the disclosure is to provide a marketing management system, a business management system, processes, and methods of use that connect to various accounts simultaneously for easy management of agency accounts and/or freelancer accounts.

Yet another object of the disclosure is to provide a marketing management system, a business management system, processes, and methods of use that allow for multiple business profiles.

Another object of the disclosure is to provide a marketing management system, a business management system, processes, and methods of use that provide easy use and integration by an agency.

Yet another object of the disclosure is to provide a marketing management system, a business management system, processes, and methods of use that provide data tracking.

Another object of the disclosure is to provide a marketing management system, a business management system, processes, and methods of use that provide website data tracking.

Yet another object of the disclosure is to provide a marketing management system, a business management system, processes, and methods of use that provide keyword optimization.

Another object of the disclosure is to provide a marketing management system, a business management system, processes, and methods of use that provide for management of various websites.

Yet another object of the disclosure is to provide a marketing management system, a business management system, processes, and methods of use that provide for management of multiple advertisements.

Another object of the disclosure is to provide a marketing management system, a business management system, processes, and methods of use that provide for management of multiple advertisement campaigns.

Yet another object of the disclosure is to provide a marketing management system, a business management system, processes, and methods of use that provide for advertisement launching.

Another object of the disclosure is to provide a marketing management system, a business management system, processes, and methods of use that are easy to use.

Yet another object of the disclosure is to provide a marketing management system, a business management system, processes, and methods of use that can run autonomously.

Another object of the disclosure is to provide a marketing management system, a business management system, processes, and methods of use that tracks historical data.

Yet another object of the disclosure is to provide a marketing management system, a business management system, processes, and methods of use that provides alerts.

Another object of the disclosure is to provide a marketing management system, a business management system, processes, and methods of use that provides a user interface.

Yet another object of the disclosure is to provide a marketing management system, a business management system, processes, and methods of use that can be used on various digital platforms.

Another object of the disclosure is to provide a marketing management system, a business management system, processes, and methods of use that are quick and efficient.

Yet another object of the disclosure is to provide a marketing management system, a business management system, processes, and methods of use that is easy to program based on predetermined rules.

Another object of the disclosure is to provide a marketing management system, a business management system, processes, and methods of use that can be customized to an agency or business needs.

Yet another object of the disclosure is to provide a marketing management system, a business management system, processes, and methods of use that is robust.

Another object of the disclosure is to provide a marketing management system, a business management system, processes, and methods of use that saves time for a user.

Yet another object of the disclosure is to provide a marketing management system, a business management system, processes, and methods of use that are high quality.

These and other objects, features, or advantages of the present disclosure will become apparent from the specification and claims.

### BRIEF DESCRIPTION OF THE DRAWINGS

FIG. 1 is an illustration of the marketing management system, a business management system, processes, and methods of use; the view showing the system and a user interacting with the system through managing accounts integrated into the system; the view showing a user interacting with a graphical user interface to accomplish various tasks and features of the system; the view showing a plurality of accounts and these accounts linked into the system; the view showing third party integration.

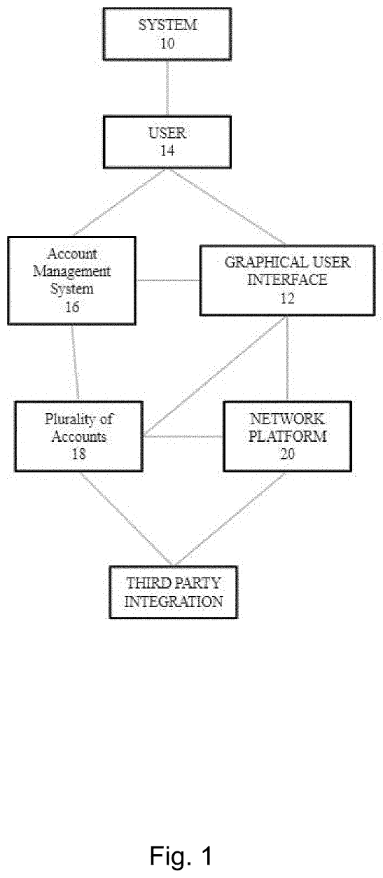

FIG. 2 is an illustration of the marketing management system, a business management system, processes, and methods of use; the view showing the system and a user interacting with the system through managing accounts integrated into the system; the view showing a user interacting with a graphical user interface to accomplish various tasks and features of the system; the view showing a plurality of accounts and these accounts linked into the system; the view showing third party integration; the view showing interactions of information incorporated into the system.

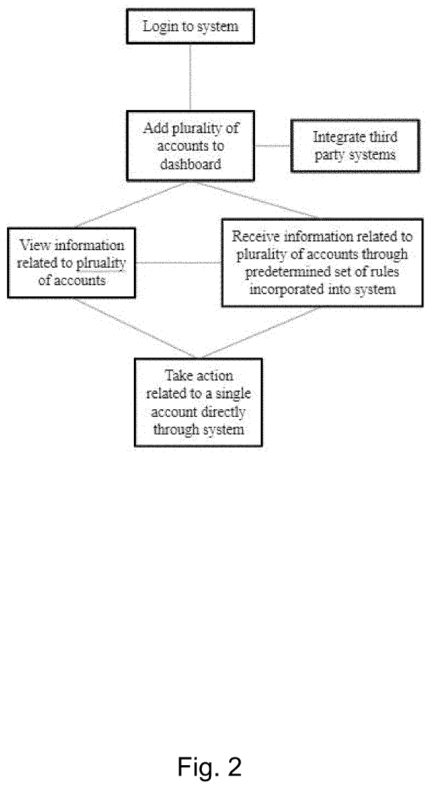

FIG. 3 is an illustration of the marketing management system, a business management system, processes, and methods of use; the view showing various features of the system; the view showing a task management system within the system; the view showing the system having a graphics library; the view showing the system having a graphic template generator; the view showing a website analytics system; the view showing a social media integration system; the view showing a phone tracking system; the view showing a search engine management system; the view showing an email marketing system; the view showing the system having a short message system tracking feature; the view showing an audit system; the view showing a keyword management system; the view showing a smart analytics system; the view showing a customer relationship management system.

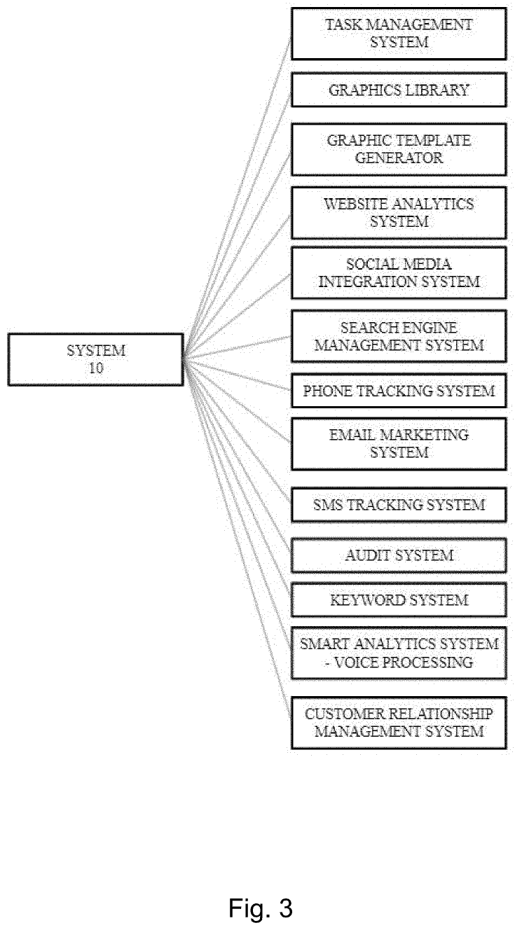

FIG. 4 is an illustration of the marketing management system, a business management system, processes, and methods of use; the view showing the dashboard of the graphical user interface; the view showing the dashboard having a task management page; the view showing the dashboard having a graphics library page; the view showing the dashboard having an advertisement generator page; the view showing the dashboard having a web analytics page; the view showing the dashboard having a social media page; the view showing the dashboard having a my business page; the view showing the dashboard having a phone number tracking page; the view showing the dashboard having a email marketing page; the view showing the dashboard having a short message service page; the view showing the dashboard having a search engine optimization page; the view showing the dashboard having a keyword research page.

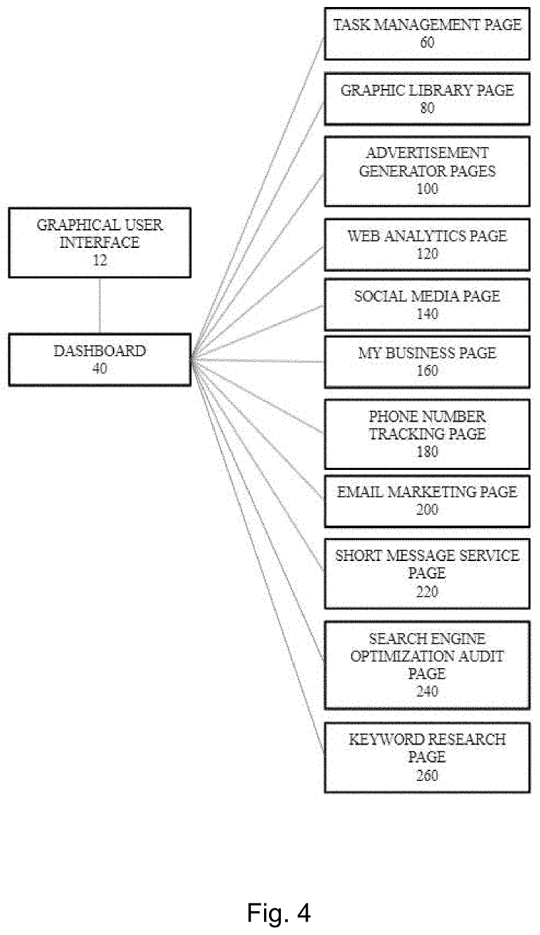

FIG. 5 is an illustration of the marketing management system, a business management system, processes, and methods of use; the view showing a dashboard; the view showing the dashboard having a notes feature; the view showing the dashboard having a manage tasks link; the view showing the dashboard having an insights feature; the view showing the dashboard having a contacts feature; the view showing the dashboard having a website traffic feature; the view showing the dashboard having a conversions indicator; the view showing the dashboard having a latest posts feature; the view showing the dashboard having a daily spend indicator; the view showing the dashboard having a recent activity feature; the view showing the dashboard having a quick reports feature.

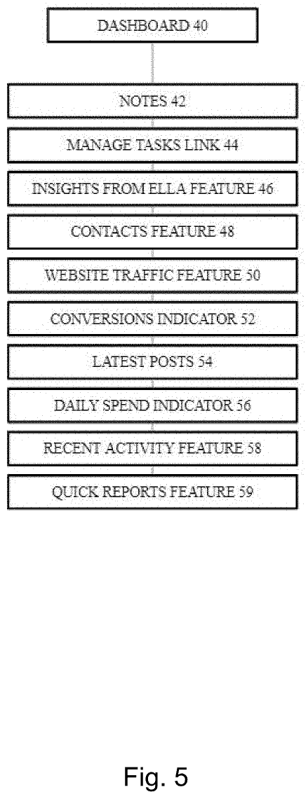

FIG. 6 is an illustration of the marketing management system, a business management system, processes, and methods of use; the view showing third party platform integration.

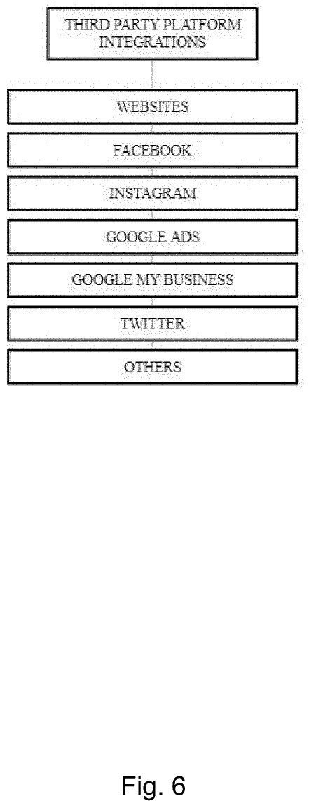

FIG. 7 is an illustration of the marketing management system, a business management system, processes, and methods of use; the view showing the keyword features; the view showing the keyword features include a keyword research feature; the view showing the keyword features include a keyword monitoring feature; the view showing the keyword features include a current keyword trends feature; the view showing the keyword features include a search rankings feature; the view showing the keyword features include a keyword analytics feature; the view showing the keyword features include a keyword guidance feature.

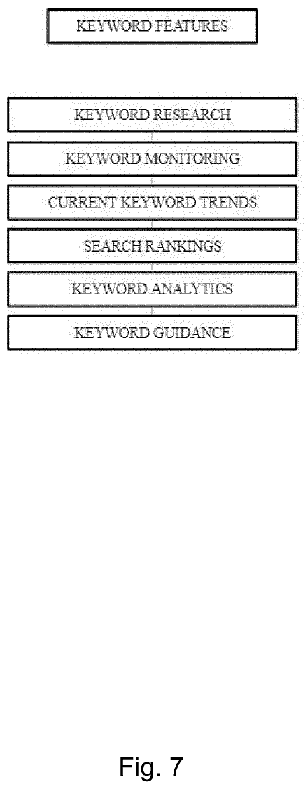

FIG. 8 is an illustration of the marketing management system, a business management system, processes, and methods of use; the view showing search engine optimization features; the view showing a search engine integration feature; the view showing a search engine auditing feature; the view showing a search engine guidance feature.

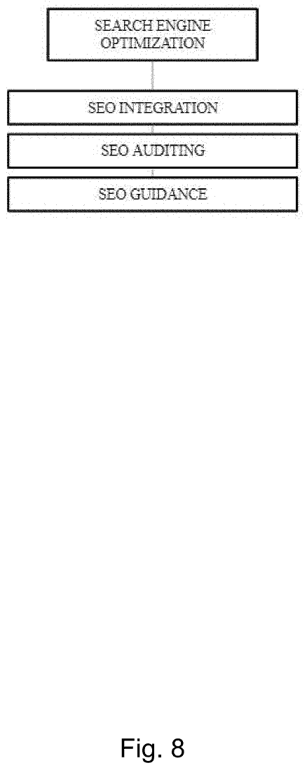

FIG. 9 is an illustration of the marketing management system, a business management system, processes, and methods of use; the view showing a task management feature; the view showing the task management feature having a contacts feature with a plurality of contacts; the view showing the task management feature having an assign tasks feature; the view showing the task management feature having a track time feature; the view showing the task management feature having a track progress feature; the view showing the task management feature having a notifications feature; the view showing the task management feature having a due dates feature; the view showing the task management feature having a late notice feature.

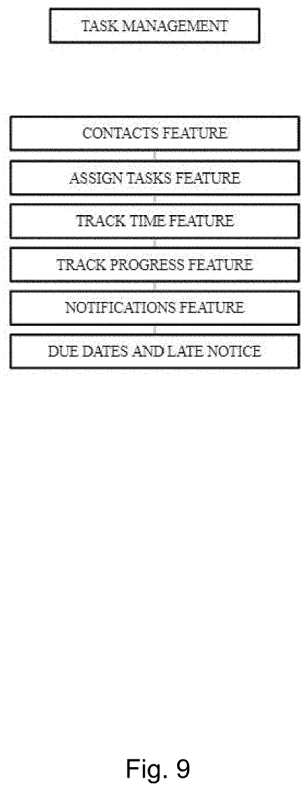

FIG. 10 is an illustration of the marketing management system, a business management system, processes, and methods of use; the view showing the system interacting with an application server; the view showing the system interacting with a remote server; the view showing the system interacting with a smart device; the view showing the system interacting with an application programming interface; the view showing the system interacting with a cloud computing system.

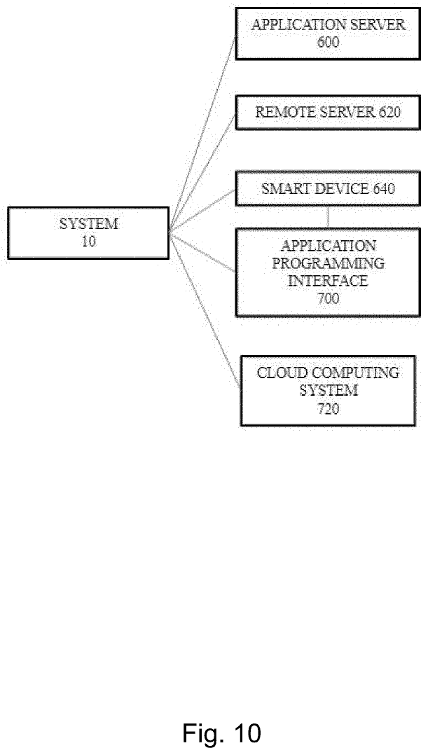

### DETAILED DESCRIPTION OF THE DISCLOSURE

In the following detailed description, reference is made to the accompanying drawings which form a part hereof, and in which is shown by way of illustration specific embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the disclosure(s). The following detailed description is, therefore, not to be taken in a limiting sense, and the scope of the disclosure(s) is defined only by the appended claims, along with the full scope of equivalents to which such claims are entitled.

As used herein, the terminology such as vertical, horizontal, top, bottom, front, back, end, sides and the like are referenced according to the views, pieces and figures presented. It should be understood, however, that the terms are used only for purposes of description, and are not intended to be used as limitations. Accordingly, orientation of an object or a combination of objects may change without departing from the scope of the disclosure.

Reference throughout this specification to “one embodiment,” “an embodiment,” “one example,” or “an example” means that a particular feature, structure, or characteristic described in connection with the embodiment or example is included in at least one embodiment of the present disclosure. Thus, the appearance of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium.

Any combination of one or more computer-usable or computer-readable media may be utilized. For example, a computer-readable medium may include one or more of a portable computer removable drive, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code, or virtual code, or framework code suitable for the disclosure herein, or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“Saas”), Platform as a Service (“PaaS”), and Infrastructure as a Service (“IaaS”)), and deployment models (e.g., private cloud, community cloud, public cloud, and hybrid cloud).

The flowchart and block diagrams in the attached figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

In the arrangement shown, as one example, a marketing management system, a business management system, processes, and methods of use are presented.

System:

With reference to the figures, a marketing management system, a business management system, processes, and methods of use 10 are presented. Marketing management system, a business management system, processes, and methods of use 10 (hereafter referred to as “marketing management system”, “marketing system”, “business management system”, “marketing coordination system”, or simply “system”) is formed of any suitable size, shape and design.

In the arrangement shown, as one example, marketing management system 10 is designed and configured to help businesses manage their digital marketing profiles. Furthermore, marketing management system 10 is designed and configured to help businesses and individuals manage their marketing assets, assign tasks, and more in an all-in-one interactive environment.

In this way, system 10, provides for task management, cloud storage for images and videos, third party integration for marketing products, social media integration, web analytics, phone and conversation tracking, and more as will become apparent from the present disclosure. Furthermore, the present disclosure provides these features and tools in an all in one interactive graphical user interface environment. In this way, individuals, businesses and business owners, and/or marketing organizations may manage and scale online presence without expensive agency management or additional freelance and employee costs. Said another way, the present disclosure provides for management of a plurality of marketing accounts, in one easy to use way.

In the arrangement shown, as one example, and said another way, system 10 is designed and configured to provide task management—allowing users to assign tasks and manage important tasks, upload store and post graphics in a library for use with advertisements and/or advertisement campaigns, generate graphics related to advertisements and the like for use on social media, analyze and track performances of web pages and campaigns and more, track and manage social media posts and accounts, track and manage search engine optimization and other search engine tools, track and manage phone communications, track and manage email marketing, track and manage short messaging service marketing, track and manage search engine optimization marketing and auditing, among other features, components, and functionality.

Furthermore, and in the arrangement shown as one example, system 10 is designed and configured to provide smart, machine learning, analytics that can be presented in an easy to understand voice and/or written format. These tools provide valuable insights to a user in the management of marketing accounts and more. Furthermore, the present disclosure provides a functional customer relationship management system—integrated into the system 10—which allows for management of contacts, addition of contacts, removal of contacts, sending messages and other communications to contacts, and more—all from within the system.

In the arrangement shown, as one example, marketing management system 10 is configured to increase the convenience in designing, creating, managing, launching and maintaining marketing tasks, and creation of advertisements and advertisements campaigns. Furthermore, the present disclosure, while providing ease and organization and simplification, also provides for integration of various accounts and systems. Furthermore, the marketing management system 10 also provides for creation of advertisements and/or marketing schemes and/or advertisement campaigns. Furthermore, the marketing system 10 also provides data and analysis related to this information, provides recommendations to a user, and enhances the success of marketing.

Furthermore, and in the arrangement shown, system 10 provides for integration of a plurality of accounts for management for firms and the like. Furthermore, the integrations with ecommerce, phone services, online services, social media services, and task management provide for further simplification and management. In this way, the present disclosure also provides for designing, creating, and launching ads and/or advertisement campaigns, based on a product and/or service, of different variations, through different accounts, while dynamically modifying graphics and the like.

In the arrangement shown, as one example, marketing management system 10 may comprise remote servers, databases, application servers, application databases, product databases, mobile applications, and/or computers; all of which in continuity or as separate acts fulfill the functions disclosed herein. Management system 10 also includes, in the embodiment(s) depicted, a graphical user interface 12, a user 14, an account management system 16, a plurality of accounts 18, a network platform 20, an application server, and a mobile computing application, among other components, features, and functions.

In the arrangement shown, as one example, the graphical user interface 12 and system 10 also include a dashboard 40, a graphics library feature 80, an advertisement generator 100, a web analytics feature 120, a social media page feature 140, a my business feature 160, a phone number tracking feature 180, an email marketing feature 200, a short message service feature 220, a search engine optimization component 240, a keyword research component 260, an application server 600, a remote server 620, a smart device 640, an application programming interface 700, and a cloud computing system 720 , among other components, features, and functionality.

Graphical User Interface:

In the arrangement shown, as one example, system 10 may include a graphical user interface 12. Graphical user interface 12 is formed of any suitable size shape and design and is configured to allow a user to view interact with, manipulate, and visually access the marketing management system 10, the marketing management system 10 data and information, information related thereto, and/or view various data for various accounts integrated into the system 10 and/or various graphics and graphical systems and/or advertisements and/or advertising campaigns and/or task management and/or business search optimization and/or marketing emails change the settings and other system operations.

Graphical user interface 12 is an exemplary method by which systems of the present disclosure may integrate with various accounts, manage various accounts, perform these tasks remotely and/or make programming changes to the operation of system 10. Employing graphical user interface 12, enhances a user's interactions with system 10 in the form of awareness and knowledge of data within the system 10. System 10 provides direct links to a user's history, settings, programming, and other information related to a particular marketing management account and/or a particular marketing job and/or a particular client associated with such marketing accounts and tasks.

In this way graphical user interface 12 provides for a means for a user to make adjustments to the operation and functionality of system 10. Additionally, graphical user interface 12 provides direct interaction with the users various accounts such as in the circumstances of a marketing agency, a small business, and more. Additionally, local geographic information with relation to the system can be added, viewed, or retrieved, such as targeted advertisements and the like.

Display of Graphical User Interface: In the arrangement shown, as one example, system 10 includes a graphical user interface 12. Graphical user interface 12 may include a display, which is configured to show and display information, including data, for review and interpretation by a user or plurality of users, or a plurality of users interacting with one another.

In the arrangement shown, as one example, interactive user display is formed of a display screen, such as that of a desktop computer, laptop computer, monitor, tablet, smart phone, smart TV, projector, virtual reality display or any other device or form of a display. In the arrangement shown, as one example, interactive user display comprises a series of interactive user display pages, however, the interactive user display may consist of a single page or any other method of displaying information on a display as could be adapted to various size screens, devices, or user preferences. The interactive user display can display various patient and/or medical information which is retrieved and/or requested.

User (or plurality thereof):

In the arrangement shown, as one example, system 10 includes a user 16. User 16 may be any user interacting with or utilizing the system 10. This may include viewing, controlling, analyzing, manipulating, and/or interacting with system 10. User 16 is not limited to a single user but may be a plurality of users. In one embodiment, a user may be a business owner or employee of a business managing various accounts and tasks and other features associated with system 10. In another embodiment, a user may be an individual utilizing system 10 for various features. In another embodiment, a user may be an employee interacting with system 10 and utilizing the features of system 10. In another embodiment, a user may be a marketing agency utilizing system 10 for the management of various accounts and various entities associated with the various accounts. Users may interact with one another via system 10 and the like.

Account Management System:

Dashboard:

In the arrangement shown, as one example, system 10 includes a dashboard 40. Dashboard 40 is formed of any suitable size, shape, and design and is configured to provide for easy navigation of a user between various accounts and various management items.

In the arrangement shown, as one example, dashboard 40 includes a notes feature 42, a manage tasks links 44, an insights from ella feature 46—which provides valuable feedback in marketing operations and tasks—a contacts feature 48—for the management of customer relationships and other contacts—a website traffic feature 50—for viewing information related to data tracking and web analytics of various platforms—a conversions indicator 52, a latest posts feature 54, a daily spend indicator 56, a recent activity feature 58, a quick reports feature 59, and a task management system 60.

Graphics Library:

In the arrangement shown, as one example, system 10 includes a graphics library feature 80. Graphics library feature 80 is formed of any suitable size, shape, and design and is configured to provide a dynamic graphics portal which provides food cloud storage of various graphics, templates, advertisements layouts, and the like. Furthermore, teh graphics library feature 80 is configured to provide the ability to access and post directly from the portal various advertisements and/or advertisement campaigns the like.

Furthermore, the graphics library feature 80 also includes providing data and tracking of information including providing insights to a user, impressions click tracking data, session tracking data and other various metrics and tracking.

Advertisement Generator:

In the arrangement shown, as one example, system 10 includes an advertisement generator 100. Advertisement generator 100 is formed of any suitable size, shape, and design and is configured to create and/or automatically generate templates based on pre existing rules and/or pre existing templates—which can be used to create graphics for online marketing, for social media marketing campaigns and the like.

Web Analytics Feature:

In the arrangement shown, as one example, system 10 includes a web analytics feature 120. Web analytics feature 120 is formed of any suitable size, shape, and design and is configured to manage and track data related to a plurality of accounts. This data and tracking also is utilized by the system to provide insights and feedback and/or suggestions. Furthermore, the system includes a predetermined set of rules for providing feedback, which also include machine learning to improve the rules and feedback on an ongoing basis as advertisements and accounts change, and the like.

In the arrangement shown, as one example, all of the features can be tracked and monitored and data provided, including but not limited to advertisement data and tracking. These features include providing data and tracking of information including providing insights to a user, impressions click tracking data, session tracking data and other various metrics and tracking.

Social Media Page Feature:

In the arrangement shown, as one example, system 10 includes a social media page feature 140. Social media feature 140 is formed of any suitable size, shape, and design and is configured to integrate and manage social media accounts, including but not limited to, posting on various social media accounts, advertising and/or launching advertising campaigns on social media accounts, and the like.

My Business Feature:

In the arrangement shown, as one example, system 10 includes a my business feature 160. My business page feature 160 is formed of any suitable size, shape, and design and is configured to integrate and manage third party accounts, including but not limited to, tracking and optimization of business accounts, search engine optimization, advertising and/or launching advertising campaigns on third party accounts, managing business tools, and the like. Furthermore, the present disclosure provides for search engine optimization auditing, putting websites into a position of success, providing pages and making suggestions on changes to each page to improve third party interactions, and more.

Phone Number Data Tracking Feature:

In the arrangement shown, as one example, system 10 includes a phone number tracking feature 180. Phone number tracking feature 180 is formed of any suitable size, shape, and design and is configured to provide call tracking, searching for phone numbers relative to area code, purchasing local phone numbers for various campaigns, selecting local numbers, tracking call success data, incorporating tracking success of calls into overall marketing campaigns, and the like. Furthermore, the phone tracking feature 180 also is designed and configured to provide text messaging and/or short messaging campaigns, which also includes the purchase of phone numbers, dispatching messages, tracking message data success, tracking campaigns, tracking delivery rates, optimizing delivery rates, and other short messaging metrics.

Email Marketing Page:

In the arrangement shown, as one example, system 10 includes an email marketing page 200. Email marketing feature 200 is formed of any suitable size, shape, and design and is configured to provide email tracking, searching for emails relative to advertising purposes, selecting email contacts for marketing, tracking email marketing success data, incorporating success of emails into overall marketing campaigns, and the like. Furthermore, the email marketing feature 200 also is designed and configured to provide email graphics and/or email language campaigns, dispatching emails, tracking email data success, tracking campaigns, tracking delivery rates, optimizing delivery rates, and other email marketing metrics.

Short Message Service Feature:

In the arrangement shown, as one example, system 10 includes a short messaging service feature 220. Short messaging service feature 220 is formed of any suitable size, shape, and design and is configured to provide text messaging and/or short messaging campaigns, which also includes the purchase of phone numbers, dispatching messages, tracking message data success, tracking campaigns, tracking delivery rates, optimizing delivery rates, and other short messaging metrics.

Search Engine Optimization Auditing Feature:

In the arrangement shown, as one example, system 10 includes a search engine optimization feature 240. Search engine optimization audit feature 240 is formed of any suitable size, shape, and design and is configured to integrate and manage third party accounts, including but not limited to, tracking and optimization of business accounts, search engine optimization, advertising and/or launching advertising campaigns on third party accounts, managing business tools, and the like. Furthermore, the present disclosure provides for search engine optimization auditing, putting websites into a position of success, providing pages and making suggestions on changes to each page to improve third party interactions, and more.

Keyword Research Feature:

In the arrangement shown, as one example, system 10 includes a keyword research feature 260. Keyword research feature 260 is formed of any suitable size, shape, and design and is configured to optimize keyword usage through various accounts.

Task Management:

In the arrangement shown, as one example, system 10 includes a task management feature. Task management feature is formed of any suitable size, shape, and design and is configured to assign and manage tasks, track time being spent on a task, receive notifications related to a task such as when the task is completed, and more. Furthermore, the task management system also provides for notifications if over due or past due. In this way, managing accounts is more manageable whether only 5 accounts or fewer, or even up to 100 accounts or more—all of which may have different users to assign tasks to and the like.

Computing Platform:

In the arrangement shown, as one example, system 10 includes a computing platform (or “computer”, or “computer platform”). Computing platform is formed of any suitable size, shape, and design and is configured to provide computing support, power, and computing processing for both onboard computing functionality as well as communication for off-board or server computing functionality. In this way, an onboard computing system, among other components and features on top of the platform.

In the arrangement shown, as one example, system 10 includes a computer. Computers are formed of any suitable size, shape, and design and are configured to provide for the main off-board computing processing and implementation of computer handling of data from data gathering performed within and related to the integrated account management system 10. The data processing may include, but is not limited to, artificial intelligence of sorting and organizing information and/or data gathered.

Remote Computing System:

In one arrangement, as is shown, system 10 includes a remote computing system (or “remote computing device”). Remote computing devices are formed of any suitable size, shape, and design and configured to handle onboard computing operations, as are necessary for the operation of system 10. Remote computing device is connected with electronic network and/or database and/or server or cloud via communication means and includes a processor, a memory, a microcontroller, a printed circuit board, a microprocessor, a receiver/transceiver, may include at least one antenna, a power supply, and a communications system, among other components.

Computing devices may be formed of any computing device capable of displaying and manipulating data in the manners described herein. Computing devices may include for example a desktop computer, a laptop computer, a tablet, smart phone, or any other computing device or other interactive device.

Computing devices may be a single consolidated component, or alternatively, computing devices may be formed of a plurality of interconnected components that may be co-located or located at different geographic locations. Computing devices may be cloud based or it may be hardware based, or cloud capable. In addition, the connected components of computing devices , including processor, memory, software and interactive user display, may be co-located with computing devices or located at different geographic locations. That is, computing devices may be made of any form of a device or system that individually or collectively performs the computing operations of system 10.

Printed Circuit Board: In the arrangement shown, as one example, system 10 includes a printed circuit board (“PCB”). PCB is formed of any suitable size, shape and design and is configured to facilitate carrying and/or holding other components and/or parts necessary to carry out various computation and/or related functions of system 10. PCB, as one example, might be a surface mounted PCB or a through-hole PCB. PCB, as one example, is green and facilitates connecting the components and/or parts of system 10 by the use of traces and or vias. Traces are formed of any suitable size, shape and design and are configured as lines electrically connecting the components and/or parts of system 10. Vias are formed of any suitable size, shape and design and are configured as holes that connect layers of traces together. Generally, as in shown, traces and vias are soldered to connect the components and/or parts to the PCB.

In an alternative embodiment, system 10 may not include an onboard computer device 180, but instead houses only a receiver and/or transceiver for sending and/or receiving information which is both sensed and/or information which is sensed and/or captured by the image capturing devices of system 10. In this way, system 10 may be connected to a mobile computing device via a cellular connection, a direction connection, or other connections which provide a means of receiving and/or sending communications.

Microprocessor: Microprocessor is any computing device that receives and processes information and outputs commands according to instructions stored in memory. Memory is any form of information storage such as flash memory, RAM memory, a hard drive, or any other form of memory. Memory may be included as a part of or operably connected to a microprocessor. A receiver/transceiver is connected to a microprocessor. A receiver is used if one way communication is utilized, whereas a transceiver is used if two-way communication is utilized (hereinafter “transceiver”). Receiver/transceiver is connected with an antenna, such as a monopole antenna, a loop antenna, a fractal antenna, or any other form of an antenna. Antenna receives wireless signals from any other device, transmits these signals to receiver/transceiver which processes these signals and then transmits these processed signals to microprocessor which processes these signals according to instructions stored in memory. In one arrangement, system 10 re-transmits operating commands signals through receiver/transceiver so as to similarly control over-the-air communication. Communication is any form of wireless signals, or wired signals, through the air, such as a conventional remote signal, a cell phone, a wireless device, an internet connected device, a hard-wired device, or any other device capable of transmitting remote control signals.

Memory: In the arrangement shown, as an example, system 10 includes a memory. Memory may be formed of any suitable size, shape and design and is configured to facilitate selective storage and retrieval of data (including data) in association with computing devices, processors, software and interactive user display. Memory may be a single component, such as a single chip or drive or other memory device, or alternatively memory may be formed of a plurality of memory or storage components that are connected to one another that may be co-located or located at different geographic locations.

Application Server:

In the arrangement shown, as one example, system 10 comprises remote servers, databases, and/or computers that fulfill the functions disclosed and described herein. In the embodiment depicted, system 10 comprises an application server. Application server comprises one or more computer systems adapted to transmit and receive data regarding selected datasets related to various users and/or datasets related to multiple users. Application server is adapted to query databases with unique identification codes to retrieve image information and associated dashboard information related to various accounts of system 10.

Application server may transmit various account data and/or system related documents with respect to a single account and/or multiple accounts. Application server is also adapted to query a database. Additionally, application server may communicate with a cloud computing system or a mobile application, which can also be adapted to present the data in a form conducive to being viewed on a mobile device and/or handheld device.

As one of ordinary skill in the art may understand, application server, database, and other databases mentioned herein may be implemented in one or more servers. Furthermore, each may be on multiple servers to increase system efficiency, especially when handling large data gathering, following extended guidelines, extended ranges, ranges discussed herein. Additionally, multiple servers may have mirrored data to prevent data loss in case of disk failure and/or to decrease access and response times for database queries. In alternative embodiments, application server, and other database procedures may be carried out on computer-readable instructions and data stored on the customer's mobile computing device.

Smart Device:

In the arrangement shown, as one example, system 10 may include a smart device (also referred to as a “mobile phone”, a “smartphone”, or simply a “device”). Smart device 640 is formed of any suitable size, shape, and design and is configured to serve as an interface between the attractor and the user.

In this way, and as is shown in one embodiment, smart device 640 is included and configured to serve as a display screen and interaction feature. This may include, but is not limited to, programming graphical user interface, previewing various items associated with various accounts and/or advertisements and/or task management and/or time tracking and/or task assignment and/or task acceptance and/or task progress tracking and/or data viewing, modifying data, manipulating data, entering data, manipulating the devices via interactions and other functionality, changing information and providing suggestions, receiving guidance from the system, modifying other settings of the hardware components of the system (to be further described herein), and the like.

In addition to the above identified features, options, controls, and components, system 10 may also include other features and functionalities, among other options, controls, and components.

In Operation:

In one example of operation and/or method of use, In the arrangement shown, as one example, marketing management system 10 is designed and configured to help businesses manage their digital marketing profiles. Furthermore, marketing management system 10 is designed and configured to help businesses and individuals manage their marketing assets, assign tasks, and more in an all-in-one interactive environment.

In this way, system 10, provides for task management, cloud storage for images and videos, third party integration for marketing products, social media integration, web analytics, phone and conversation tracking, and more as will become apparent from the present disclosure. Furthermore, the present disclosure provides these features and tools in an all in one interactive graphical user interface environment. In this way, individuals, businesses and business owners, and/or marketing organizations may manage and scale online presence without expensive agency management or additional freelance and employee costs. Said another way, the present disclosure provides for management of a plurality of marketing accounts, in one easy to use way.

In the arrangement shown, as one example, and said another way, system 10 is designed and configured to provide task management - allowing users to assign tasks and manage important tasks, upload store and post graphics in a library for use with advertisements and/or advertisement campaigns, generate graphics related to advertisements and the like for use on social media, analyze and track performances of web pages and campaigns and more, track and manage social media posts and accounts, track and manage search engine optimization and other search engine tools, track and manage phone communications, track and manage email marketing, track and manage short messaging service marketing, track and manage search engine optimization marketing and auditing, among other features, components, and functionality.

Furthermore, and in the arrangement shown as one example, system 10 is designed and configured to provide smart, machine learning, analytics that can be presented in an easy to understand voice and/or written format. These tools provide valuable insights to a user in the management of marketing accounts and more. Furthermore, the present disclosure provides a functional customer relationship management system—integrated into the system 10—which allows for management of contacts, addition of contacts, removal of contacts, sending messages and other communications to contacts, and more—all from within the system.

In the arrangement shown, as one example, marketing management system 10 is configured to increase the convenience in designing, creating, managing, launching and maintaining marketing tasks, and creation of advertisements and advertisements campaigns. Furthermore, the present disclosure, while providing ease and organization and simplification, also provides for integration of various accounts and systems. Furthermore, the marketing management system 10 also provides for creation of advertisements and/or marketing schemes and/or advertisement campaigns. Furthermore, the marketing system 10 also provides data and analysis related to this information, provides recommendations to a user, and enhances the success of marketing.

Furthermore, and in the arrangement shown, system 10 provides for integration of a plurality of accounts for management for firms and the like. Furthermore, the integrations with ecommerce, phone services, online services, social media services, and task management provide for further simplification and management. In this way, the present disclosure also provides for designing, creating, and launching ads and/or advertisement campaigns, based on a product and/or service, of different variations, through different accounts, while dynamically modifying graphics and the like.

It will be appreciated by those skilled in the art that other various modifications could be made to the system, process, and method of use without parting from the spirit and scope of this disclosure. All such modifications and changes fall within the scope of the claims and are intended to be covered thereby.

What is claimed:

1. A marketing management system, comprising:
an application server;
an application programming interface;
an account database;
a database;
the database having a plurality of datasets;
the datasets having data;
a graphical user interface;
the graphical user interface having a dashboard, a task management page, a graphics library page, an advertisement generator feature, a web analytics page, a social media management page, a my business management feature, a phone number tracking feature, an email marketing page, a short message service page, a search engine optimization feature, a keyword research feature;
wherein a user can manage a plurality of accounts from a single interface;
wherein a user can generate a plurality of advertisements from a single template;
wherein a user can distribute a plurality of advertisements from a single launch.

2. The system of claim 1, further comprising:
a predetermined set of rules;
a machine learning feature;
wherein the predetermined set of rules provide a user with insights.

3. The system of claim 1, further comprising:
a predetermined set of rules;
a machine learning feature;
wherein the predetermined set of rules provide a user with insights;
wherein the predetermined set of rules learns with changes in the account;
wherein the predetermined set of rules provides the user with feedback and makes suggestions for improving the success of an account based on analytics collected and data collected with respect to the account.

4. The system of claim 1, further comprising:
a customer relationship management feature;
wherein the customer relationship management feature provides a user the ability to add contacts, to remove contacts, to send messages to contacts, to build landing pages, to manage leads, and to manage customers from the dashboard.

5. The system of claim 1, further comprising:
wherein the system provides insights for the management of accounts;
wherein the system provides insights based on trends;
wherein the system provides insights based on unique data from one of the plurality of accounts.

6. The system of claim 1, further comprising:
a task manager feature;
the task manager feature having a plurality of assignees;
a plurality of tasks;
wherein the task manager feature provides the ability to assign at least one of the plurality of tasks to at least one of the plurality of assignees.

7. The system of claim 1, further comprising:
a task manager feature;
the task manager feature having a plurality of assignees;
a plurality of tasks;
wherein the task manager feature provides the ability to assign at least one of the plurality of tasks to at least one of the plurality of assignees;
a plurality of notifications;
wherein the plurality of notifications provide different updates and information to a manager.

8. The system of claim 1, further comprising:
a campaign analyzing feature;
the campaign analyzing feature having a plurality of insights;
the campaign analyzing feature having a plurality of impressions;
the campaign analyzing feature having a plurality of clicks;
the campaign analyzing feature having a plurality of top pages;
the campaign analyzing feature having a plurality of sessions;
wherein the campaign analyzing feature provides feedback to a campaign manager based on a predetermined set of rules and based on data collected from a campaign.

9. The system of claim 1, further comprising:
a call tracking feature;
the call tracking feature having a search phone numbers feature;
the call tracking feature having a successful calls tracking feature;
wherein the successful calls tracking feature tracks data related to the number of successful calls completed;
wherein a successful call is a call associated with a marketing campaign.

10. A marketing account management system, comprising:
an application server;
an application programming interface;
an account database;
a database;
the database having a plurality of datasets;
the datasets having data;
a graphical user interface;
the graphical user interface having a dashboard, a task management page, a graphics library page, an advertisement generator feature, a web analytics page, a social media management page, a my business management feature, a phone number tracking feature, an email marketing page, a short message service page, a search engine optimization feature, a keyword research feature;
wherein a user can manage a plurality of accounts from a single interface;
wherein the plurality of accounts are integrated through access from the dashboard of the graphical user interface;
wherein a user can generate a plurality of advertisements from a single template;
wherein a user can distribute a plurality of advertisements from a single launch.

11. The system of claim 1, further comprising:
a predetermined set of rules;
a machine learning feature;
wherein the predetermined set of rules provide a user with insights.

12. The system of claim 1, further comprising:
a predetermined set of rules;
a machine learning feature;
wherein the predetermined set of rules provide a user with insights;
wherein the predetermined set of rules learns with changes in the account;
wherein the predetermined set of rules provides the user with feedback and makes suggestions for improving the success of an account based on analytics collected and data collected with respect to the account.

13. The system of claim 1, further comprising:
a customer relationship management feature;
wherein the customer relationship management feature provides a user the ability to add contacts, to remove contacts, to send messages to contacts, to build landing pages, to manage leads, and to manage customers from the dashboard.

14. The system of claim 1, further comprising:
wherein the system provides insights for the management of accounts;
wherein the system provides insights based on trends;
wherein the system provides insights based on unique data from one of the plurality of accounts.

15. The system of claim 1, further comprising:
a task manager feature;
the task manager feature having a plurality of assignees;
a plurality of tasks;
wherein the task manager feature provides the ability to assign at least one of the plurality of tasks to at least one of the plurality of assignees.

16. The system of claim 1, further comprising:
a task manager feature;
the task manager feature having a plurality of assignees;
a plurality of tasks;
wherein the task manager feature provides the ability to assign at least one of the plurality of tasks to at least one of the plurality of assignees;
a plurality of notifications;
wherein the plurality of notifications provide different updates and information to a manager.

17. The system of claim 1, further comprising:
a campaign analyzing feature;
the campaign analyzing feature having a plurality of insights;
the campaign analyzing feature having a plurality of impressions;
the campaign analyzing feature having a plurality of clicks;
the campaign analyzing feature having a plurality of top pages;
the campaign analyzing feature having a plurality of sessions;
wherein the campaign analyzing feature provides feedback to a campaign manager based on a predetermined set of rules and based on data collected from a campaign.

18. The system of claim 1, further comprising:
a call tracking feature;
the call tracking feature having a search phone numbers feature;
the call tracking feature having a successful calls tracking feature;
wherein the successful calls tracking feature tracks data related to the number of successful calls completed;
wherein a successful call is a call associated with a marketing campaign.

19. The system of claim 1, further comprising:
a search engine optimization feature;
wherein third party search engine optimization features are integrated into the system;
wherein the search engine optimization keywords are analyzed for each of a plurality of web pages;
wherein a suggestion is provided for each of the plurality of web pages for how to improve search engine optimization.

20. A method of managing a plurality of marketing related accounts, creating and distributing a plurality of advertisements, the steps comprising:
providing an application server;
providing an application programming interface;
providing an account database have at least one account;
providing a graphical user interface;
integrating information related to the at least one account;
analyzing information related to the at least one account;
providing suggestions regarding at least one account related to search engine optimization, third party integration, social media advertising, social media posting success, keyword searching, phone tracking, task management, text messaging campaigns, advertising graphics.
